(19) United States
(12) Patent Application Publication
(10) Pub. No.: US 2010/0035224 A1
(43) Pub. Date: Feb. 11, 2010

(54) Learning with Magnets

(75) Inventor: Maria Theresa Minard, Lumberton, NJ (US)

Correspondence Address: MARIA T. MINARD, 3 COVINGTON TERRACE, LUMBERTON, NJ, 08048, US

(73) Assignee: Maria Theresa Minard, Lumberton, NJ (US)

(21) Appl. No.: 12/157,207

(22) Filed: Aug. 6, 2008

(51) Int. Cl. G09B 19/00

(52) U.S. Cl. 434/304

(57) ABSTRACT

This is a brief description of my idea for children ages 1-5. I have come up with a learning tool to help children connect pictures with words for a daily routine calendar. It is not a typical calendar. It is more of a day to day with times and bonus days. The tool is made out of magnetic receptive paper, magnetic paper, and soft color foam. I have designed a package that goes with it to keep all the magnets. I have enclosed some photos of my idea that I have had copyrighted. I am not sure if my idea needs to be licensed, but if it does I will. I am not wanting to my idea needs a license and maybe a patent. I am not sure. I am not wanting my idea taken from me, cause I know it is the only one that exist and it will be very successful I am praying.

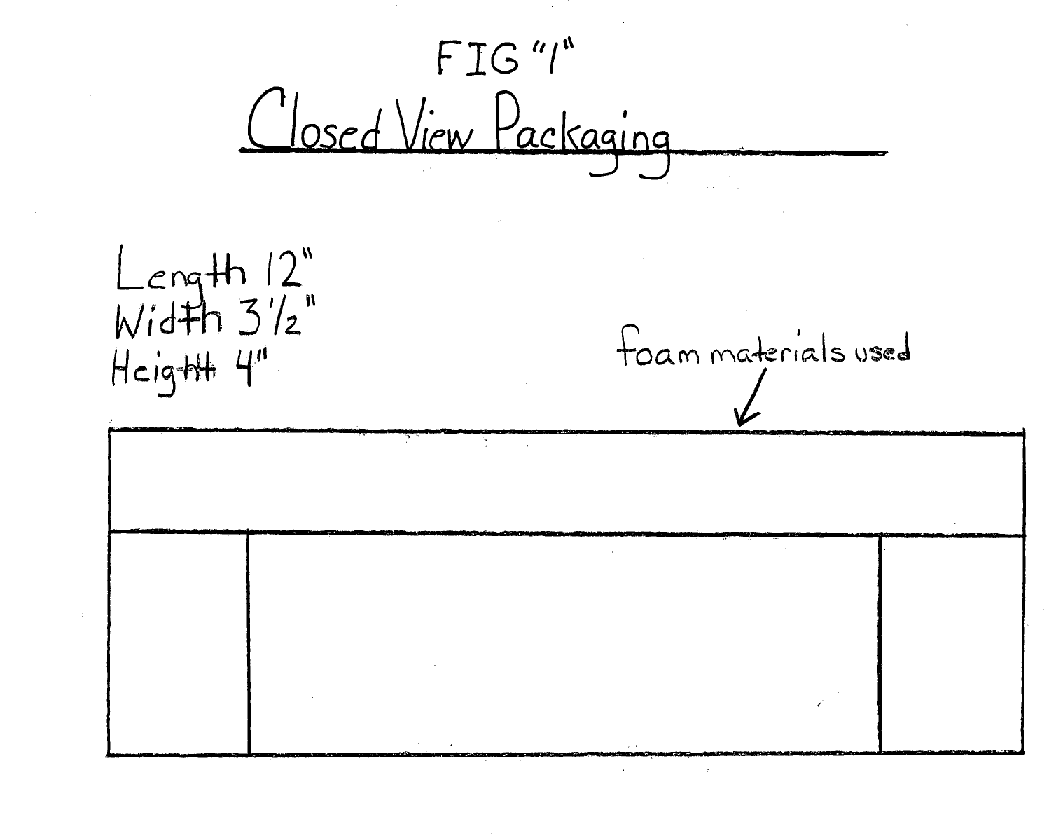

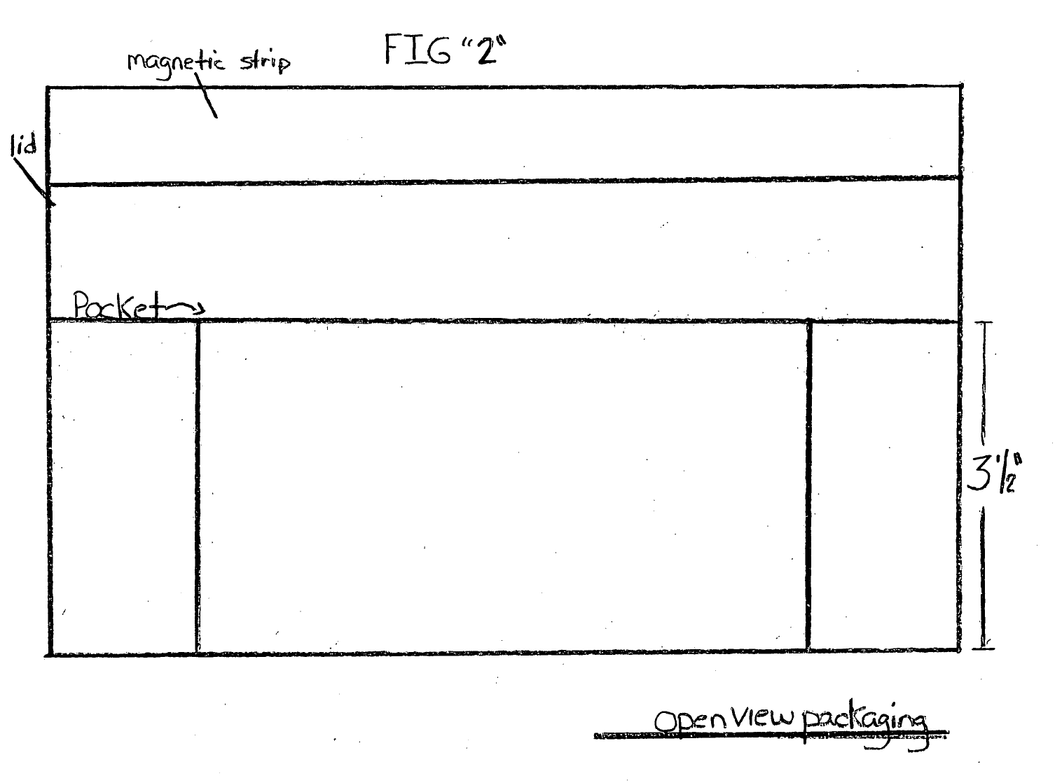

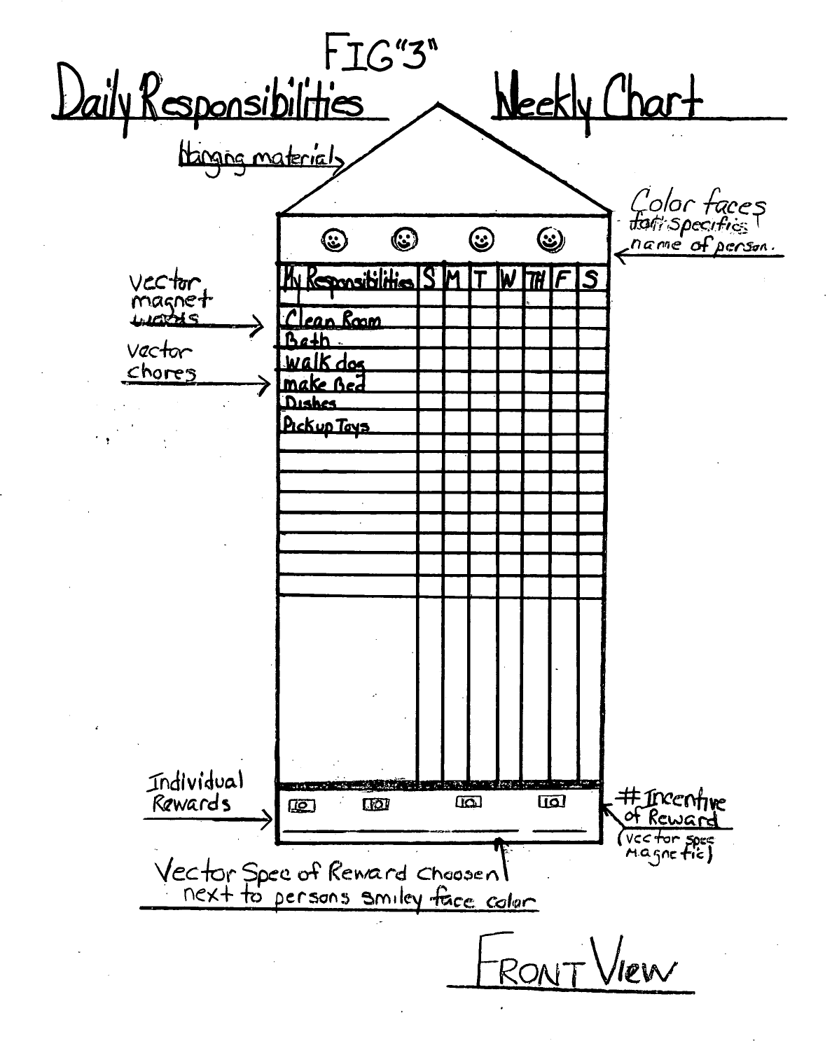

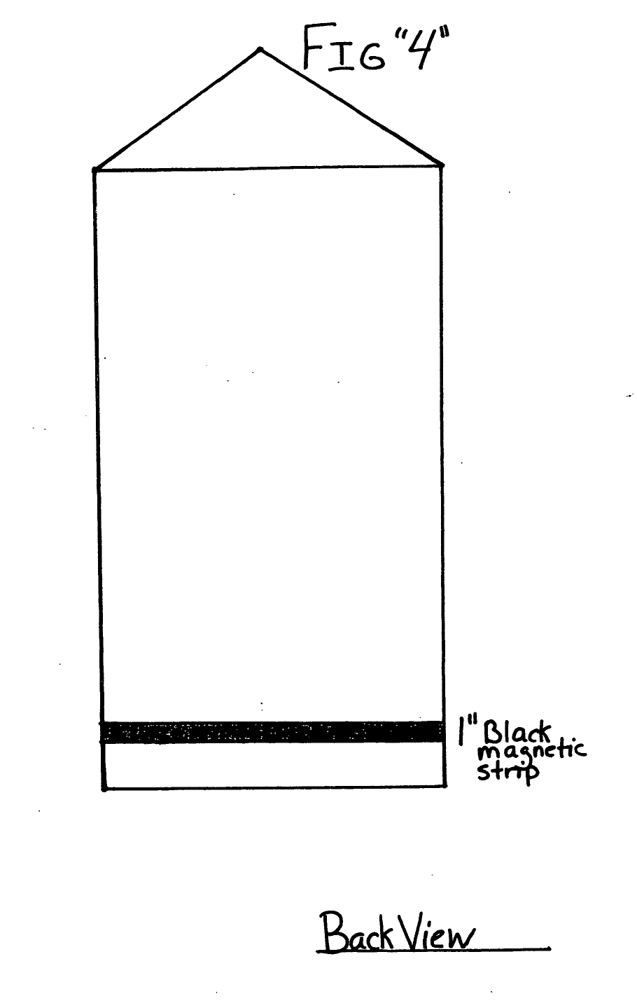

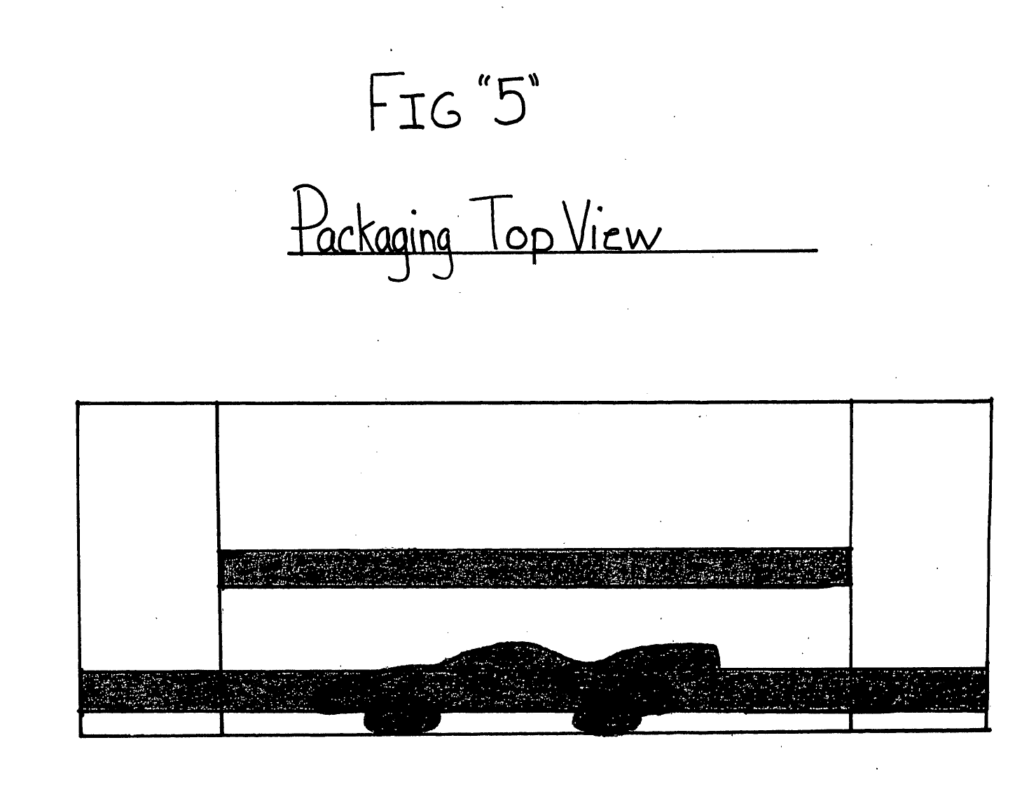

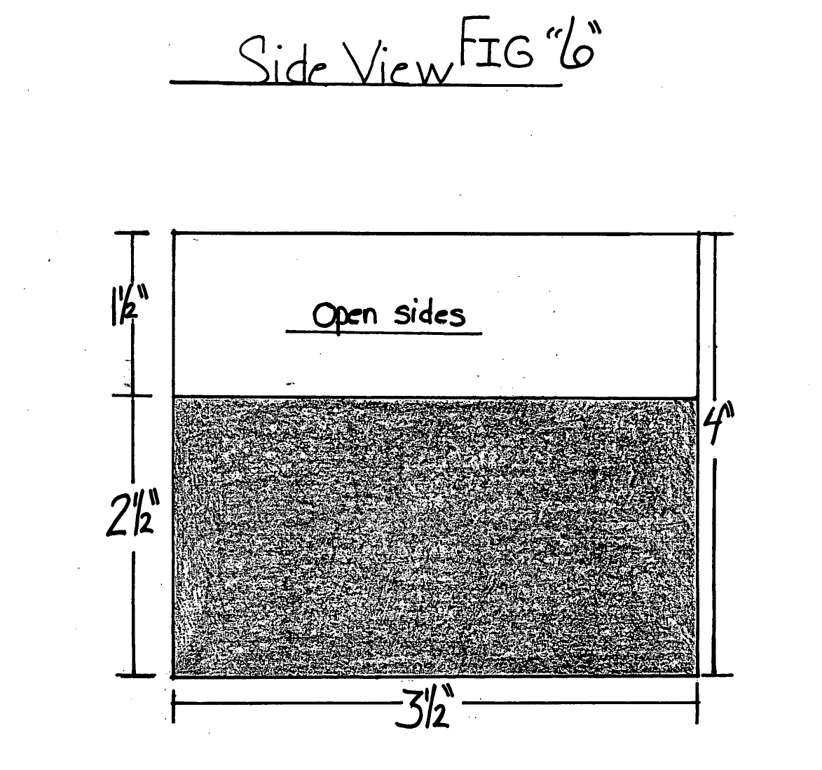

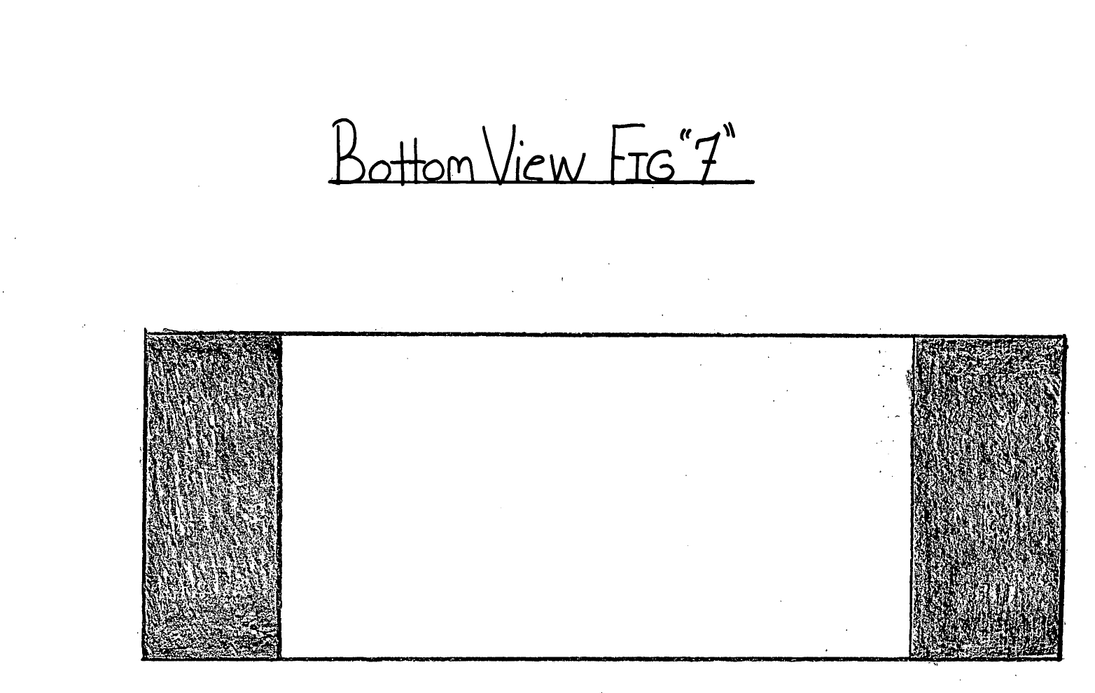

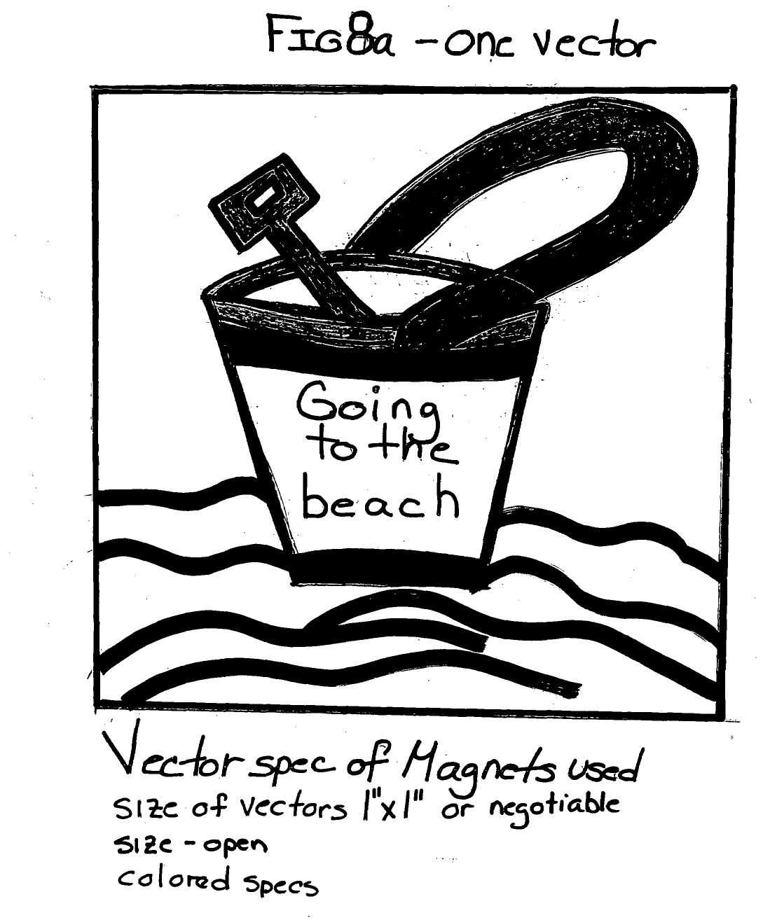

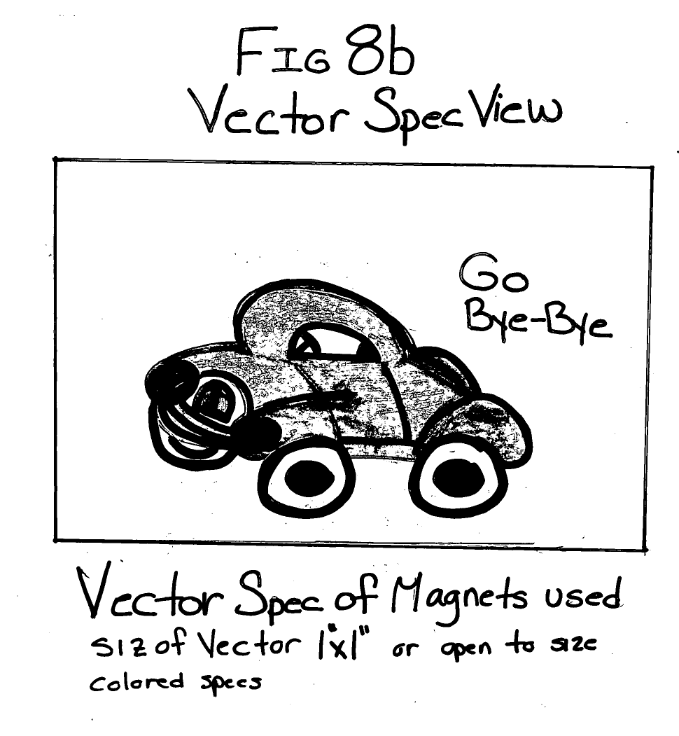

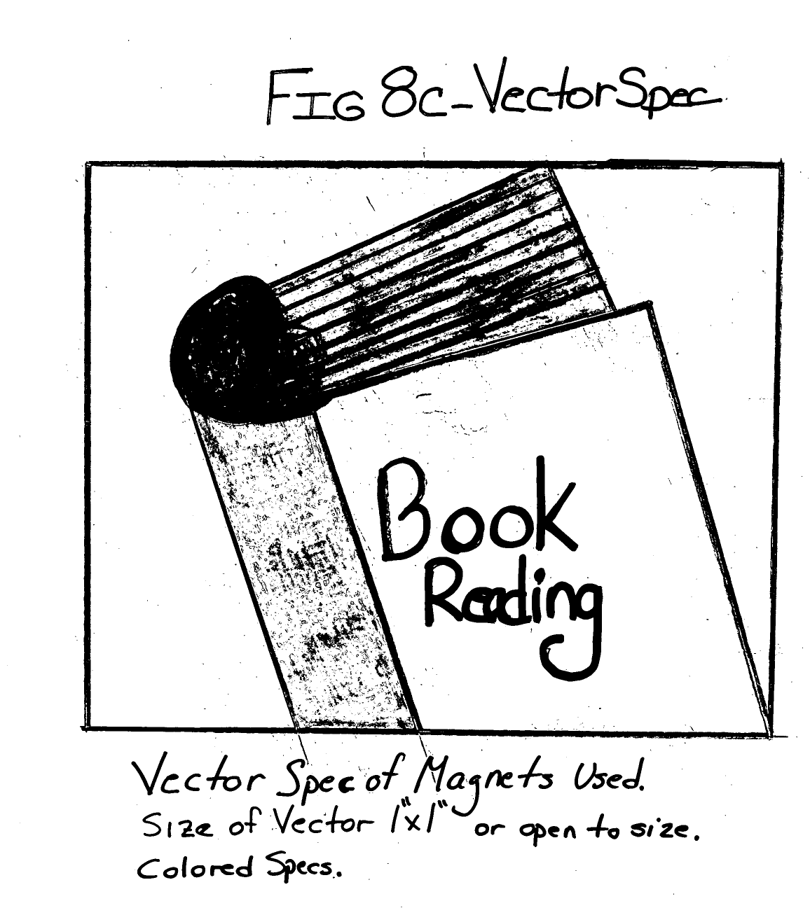

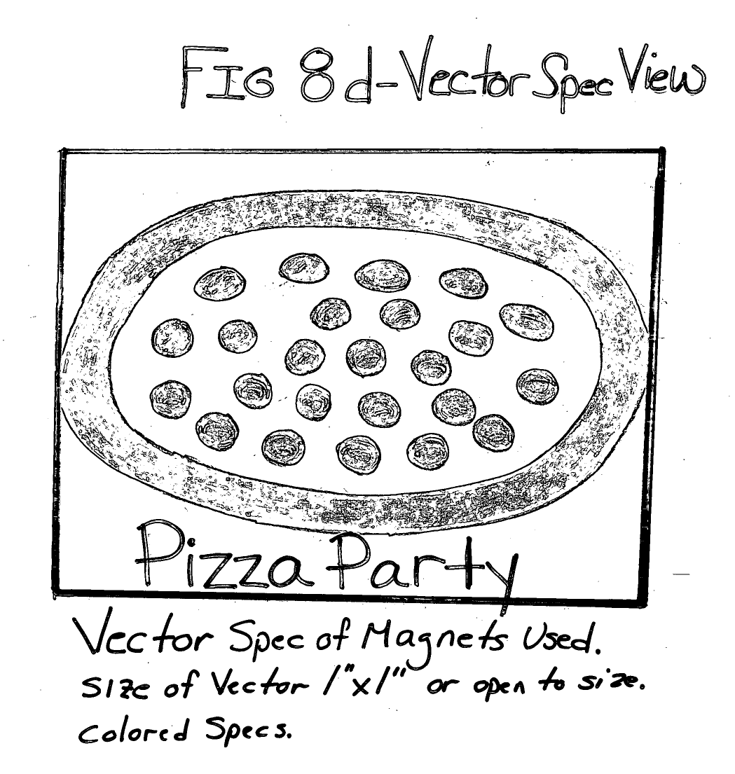

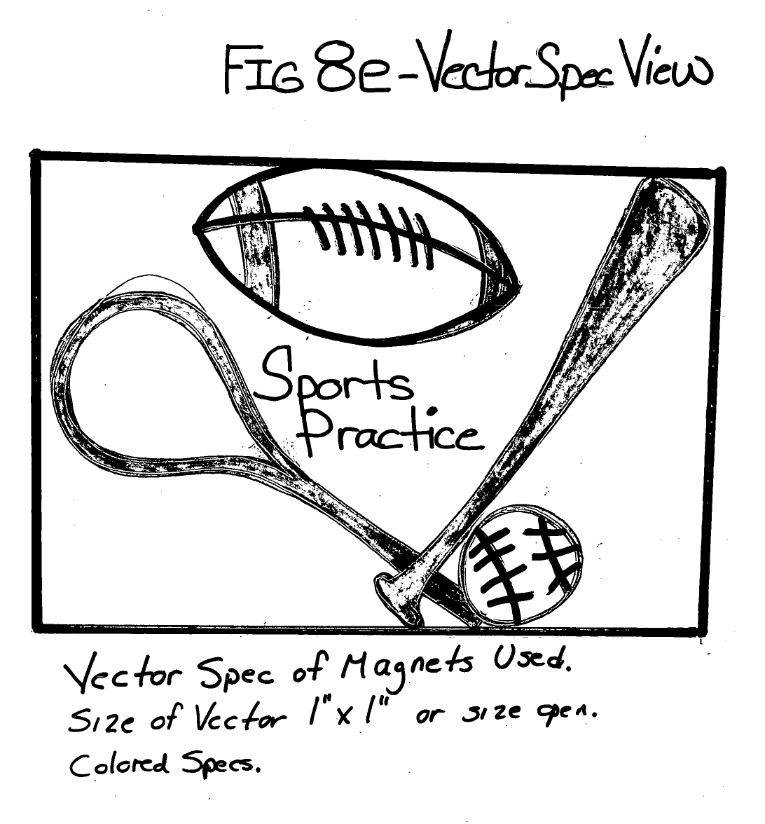

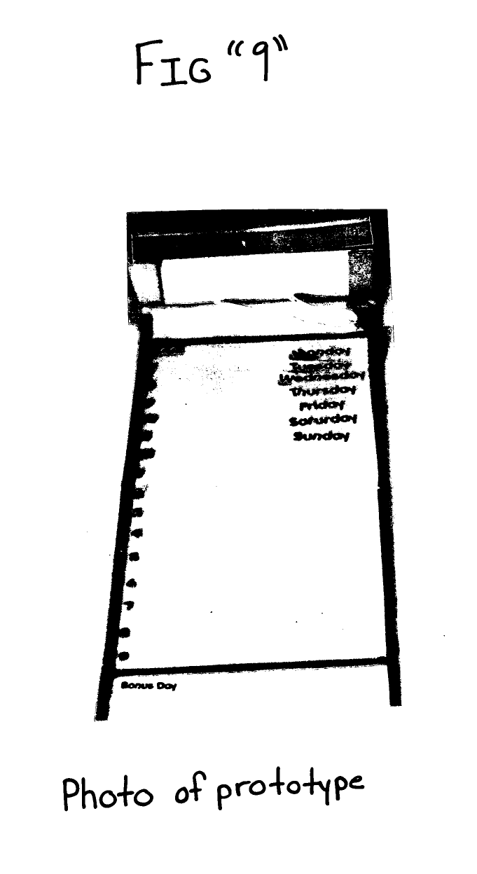

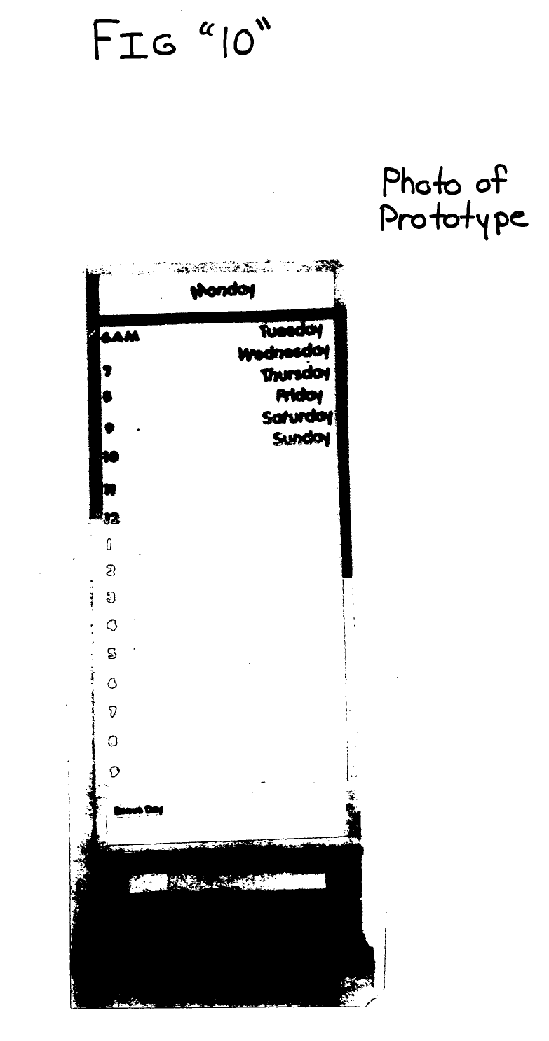

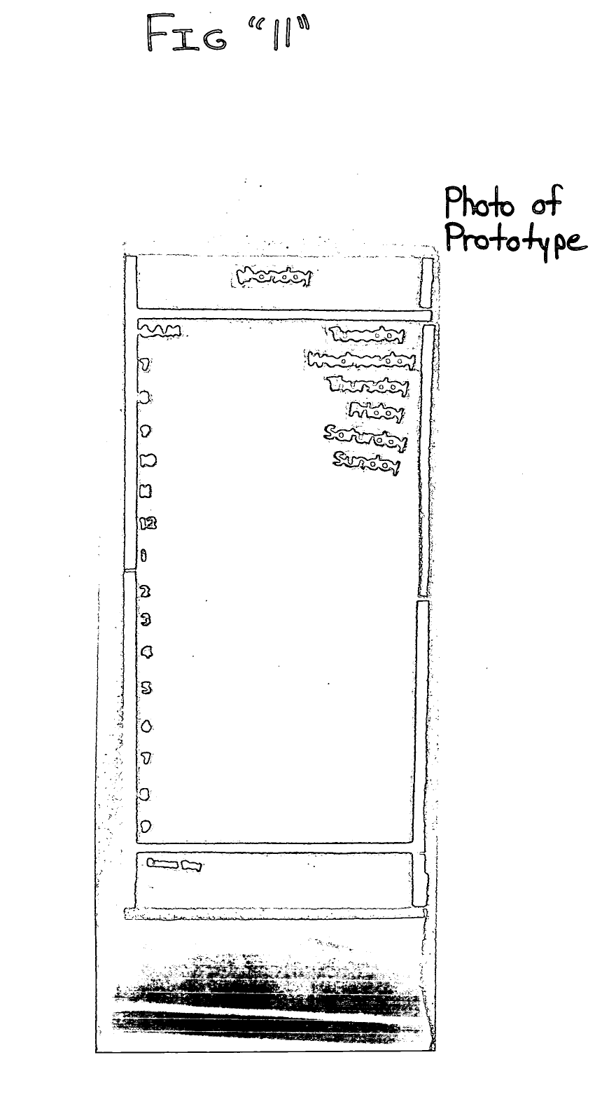

I have came up with an idea of “Learning with Magnets.” Spec for different areas of learning and organization. Ranging from the ages of 1-99 years of age. My first Spec that I am currently working on and have my prototypes are for the ages of 1-5 providing early intervention educational materials.

I have a series of ideas of this type for children and for all ages 1-unlimited years of age to learn, organize, plan, and so much more in a fun and colorful way. It is safe, fun, portable, sturdy, durable, safe, colorful, educational, provides brain development, provides positive communication and reenforcement of understanding and connecting with day to day responsibilities, Stimulates the brain in before and after effects, is flexible, and can hang anywhere. I believe this is a great idea and it has helped my son and I thank him and his love for the gift that he has given me to accomplish this idea.

The Objectives for this idea has many different areas of stimulating the before and after effect, the relativity between the picture and the word that goes with the picture, connecting time with the events, learning the responsibilities of day to day scheduling, Understanding the difference between morning, afternoon, and evening routines, Providing the challenge to apply his or her knowledge from “Learning with Magnets” to adapted to lives changes, rearranging schedules, and sudden occurrences. Which can happen at any time at any one given moment.

### OUTLINE OF OBJECTIVES

A. Stimulating the before and after effect.

B. Relating the similarity between the picture and the word that it goes with for description.

C. Connecting time with the events.

D. Learning the responsibilities of day to day scheduling.

E. Understanding the difference between Mornings, Afternoons, and Evenings.

F. Providing the challenge to apply his or her knowledge from “Learning with Magnets”
To adapted to lives changes, rearranging schedules, and sudden occurrences, which can happen at any time and at any one given moment.

Outline of my children's learning tool. This tool gives children the learning strategies for linking there daily routine with the words of there completed tasks.

Note: I have a series of ideas for different learning responsibilities and daily routines.
A. Main frame is made out of Magnetic Receptive paper.
B. Magnetic pictures with words (vectors)C. Soft constructional kids foam with colors
D. Packaging is part of the tool. It holds the magnets (vectors) that are not being used for that day or the items done for that day.
E. Includes all days of the week and time of day
F. Has a bonus day for completing the day with success
G. I have designed one for each gender. Bright colors of orange, red, and yellow for the boys. And bright colors of purple, blue green, and pink for the girls.
H. Each one can either hang on the wall, refrigerator, or where ever the consumers like.
I. It comes with many different magnets of learning ranging from getting dressed, Bath, brush teeth, make bed, playground, walk, bedtime, school bus, school, Juice, milk, dinner, lunch, breakfast, et. . . .
J. It is portable and flexible for easy traveling and storage.
K. It can be made coed or individual colors for each gender. I have made my prototypes in Colors of yellow, orange, and red for the boys and colors of pink, purple, and green for girls.
L. I have a series of ideas for this Idea of “Learning with Magnets” Ranging from Activities Spec, Menu Spec, Incentive Spec, Holiday Spec, Chores Spec, Office Spec, Working Spec, etc. . . .
M. The age for the first Spec is 1-5 years of age and the other Specs range from 1-99 years of age.
N. All Specs are made with Magnetic paper, Magnetic receptive paper, and color foam. It is soft, Durable, safe, sturdy, portable, etc. . . .
P. My ideas for these specs were founded April 2006.
Q. My first spec is for the 1-5 years of age helping in the early intervention of educational product. There rest are 1-99 years of age where everyone can benefit from different specs of Choice.
R. Product is sturdy, durable, flexible, safe, colorful, educational, provides brain development, Provides communication and connecting words to pictures and pictures to words, and provides Understanding between learning daily routines and responsibilities.

1. The Objectives for this idea has many different areas of stimulating the before and after effect, the relativity between the picture and the word that goes with the picture, connecting time with the events, learning the responsibilities of day to day scheduling, Understanding the difference between morning, afternoon, and evening routines, Providing the challenge to apply his or her knowledge from “Learning with Magnets” to adapted to lives changes, rearranging schedules, and sudden occurrences. Which can happen at any time at any one given moment.
